(19) United States
(12) Patent Application Publication
(10) Pub. No.: US 2022/0042535 A1
(43) Pub. Date: Feb. 10, 2022

(54) Umbrella Anchoring System

(71) Applicant: James Ernest Martorelli, Palm Bay, FL (US)

(72) Inventor: James Ernest Martorelli, Palm Bay, FL (US)

(21) Appl. No.: 16/988,584

(22) Filed: Aug. 7, 2020

(51) Int. Cl. F16B 13/06

(52) U.S. Cl. CPC F16B 13/065

(57) ABSTRACT

This invention is a movable, transferable and reusable umbrella type anchor for suspending or securing attachments to a hollow back surface.

### TYPE OF INVENTION

The UMBRELLA ANCHORING SYSTEM is a mechanical device for various fields of technology to be enumerated later in this document.

### INVENTORSHIP

The UMBRELLA ANCHORING SYSTEM has never been used or available publicly, sold, patented, or included in any publication. I, James E Martorelli, am the sole inventor Provisional Patent: Jul. 2, 2019 APP. NOS. 62/869/796. Patent Search: Legal Zoom 63030528.

### BACKGROUND OF THE INVENTION

There was a problem for installers when wallpapering a ceiling. How can one support a whole roll of wallpaper overhead while using two hands to install? How can that weight be transfered to another location quickly and safely?

The problem with the anchoring of attachments into a hollow back surfaces (HBS), like a ceiling, is that the anchor may secure an attachment but is unable to be removed, relocated and reused. Few, if any, fasteners and anchors are able to quickly move and re-anchor in another location in hollow back surfaces (HBS), such as drywall or pegboard walls and ceilings, while holding attachments.

### BACKGROUND OF THE INVENTION

The solution that has been adopted, generally, for securing or suspending attachments from HBS have been a two part system featuring an anchoring portion with a conventional fastening member, like a screw or bolt. Plastic anchors often break, disintegrate after one use. There are others that, after passing through an entry hole in the HBS, expand a portion of the anchoring member or deform it so as to provide a truss-like arrangement preventing its passing back through said entry hole. A toggle bolt may be strong enough to hold an attachment yet, when moved, the anchoring part disappears behind the hollow surface and must be replaced. Typical such fastening members are described in the patent art, exemplified by U.S. Pat. Nos. 1,295,734. 3,431,813. 4,009,634. and 4,500,238 among others. In pegboard walls, the most common anchor moves quickly and supports weight but is useless for ceilings. U.S. Pat. No. 5,180,128 Massey

Though there are numerous hollow wall anchors and fasteners known, there is still a need for one that satisfies the shortcomings of the above mentioned problems specifically, being movable, multi-directional and dual functioning, namely, to secure attachments to a hollow backed surface (HBS), and suspend attachments from a hollow back surface (HBS), keeping the ability to quickly transfer the attachments and re-anchor them in another location. That need was expressed in Provisional Patent: Jul. 2, 2019 No. 62/869/796.

### SUMMARY OF THE INVENTION (CONT.)

The determination of the material used for the tube, and thus its ribs, depends on its purpose. Factors like strength, speed of release, springback properties, and surface friction must be considered.

The UAS will suspend an attachment from an entry hole in a HBS. When a threaded rod or machine screw is rotated into the GUIDE, down through the ribs and through the SLIDE, an attachment that is equipped with a post of the same thread size, such as a hook, can be suspended from an HBS. The GUIDE of the UAS starting the penetration into the entry hole of the HBS and the SLIDE stopping entry of the UAS into the entry hole of the HBS.

The UAS will also secure attachments to an HBS when a threaded rod, or screw, is inserted into the SLIDE, down through the tube ribs and removably secured into the GUIDE. Attachments can be placed along the shaft, on the distal end or in front of the screw head, as well as between the SLIDE section of the UAS and the outside surface of he HBS.

The GUIDE section is drawn toward the SLIDE section slowly by rotating the threaded rod through the GUIDE section or quickly by sliding the SLIDE section up the shaft toward the GUIDE section leaving an elongated shaft and the screw head. Attachments can be placed along said shaft, between the screw head and the SLIDE. To secure them, draw them together by rotating the screw head into the GUIDE.

### SUMMARY OF THE INVENTION (CONT.)

Inside the entry hole, the tube ribs will collapse radially with respect to the screw shaft axis when the GUIDE moves lineally toward to the SLIDE creating the umbrella like ANCHOR section having a larger diameter than the entry hole prevent passage back.

To remove, the UAS is closed or flattened by moving the SLIDE and the GUIDE away from each other, flattening the umbrella ANCHOR section and allowing the UAS passage back through the entry hole.

Besides being movable and able to both suspend and secure attachments, the UAS has the advantage of staying on the screw shaft when its being removed and relocated.

Surface damage is also minimized since the UAS works lineally by compressing attachments together along the screw shaft.

Another advantage over other fasteners and anchors may be in manufacturing and marketing. The part and material options are versatile expanding ideas for design, strength, springback, transfer speed and other purposes.

### SUMMARY OF THE INVENTION (CONT.)

Inside the entry hole, the tube ribs will collapse radially with respect to the screw shaft axis when the GUIDE moves lineally toward to the SLIDE creating the umbrella like ANCHOR section having a larger diameter than the entry hole prevent passage back.

To remove, the UAS is closed or flattened by moving the SLIDE and the GUIDE away from each other, flattening the umbrella ANCHOR section and allowing the UAS passage back through the entry hole.

Besides being movable and able to both suspend and secure attachments, the UAS has the advantage of staying on the screw shaft when its being removed and relocated.

Surface damage is also minimized since the UAS works lineally by compressing attachments together along the screw shaft.

Another advantage over other fasteners and anchors may be in manufacturing and marketing. The part and material options are versatile expanding ideas for design, strength, springback, transfer speed and other purposes.

### BRIEF DESCRIPTION OF THE DRAWINGS

FIG. 1 is the UMBRELLA ANCHORING SYSTEM (UAS) showing the SLIDE, GUIDE, and ANCHOR sections, as well as the fastener screw.

FIG. 2 is the exploded view of the parts and the two MODE options for the entry screw.

FIG. 3 is the relationship of the parts, their relative sizes and shapes, and their alignment on the screw shaft with side elevation and top views.

FIG. 4 is the screw fastener assembled into the UAS showing both the SECURE MODE and SUSPEND MODE.

FIG. 5 is the UAS in the SECURE MODE with entry hole into the HBS.

FIG. 6 is the GUIDE of the UAS penetrating the entry hole in the SECURE MODE with top, side and bottom elevations.

FIG. 7 is the fully inserted UAS into the entry hole showing SLIDE section against the outside of the HBS in the SECURE MODE.

FIG. 8 is the GUIDE drawn closer to the SLIDE as the screwhead is pulled away from the SLIDE. In this SECURE MODE, ANCHOR section of tube ribs collapses into an umbrella-like anchoring splash in the space behind the HBS. Attachments are placed in locations (A) and/or (B). (D) is the distance required to reach from the outside surface to the space inside. the HBS where the umbrella anchor splash can open.

FIG. 9 is the UAS in the SECURE MODE viewed with the clamp/stopper in position, and the movement of the fastener screw as it is rotated into the GUIDE.

### BRIEF DESCRIPTION OF THE DRAWINGS

FIG. 10 is the UAS in the SECURE MODE viewed from the outside surface of HBS and the options for tube slices and tube ribs.

FIG. 11 is the UAS in the SUSPEND MODE with entry hole into the HBS.

FIG. 12 is the GUIDE entering the entry hole showing top, bottom and side elevations in the SUSPEND MODE FIG. 13 is the fully inserted UAS into the entry hole showing SLIDE section against the outside of the HBS in the SUSPEND MODE

FIG. 14 shows the UAS with the anchor splash open, in the SUSPEND MODE, with the distal end placement position (C) for attachments

FIG. 15 is the options for splash(14) formations after the UAS is opened as viewed from the inside space behind the HBS.

FIG. 16 gives an alternative relationship and alignment of parts when making the UAS

### DETAILED DESCRIPTION OF THE INVENTION

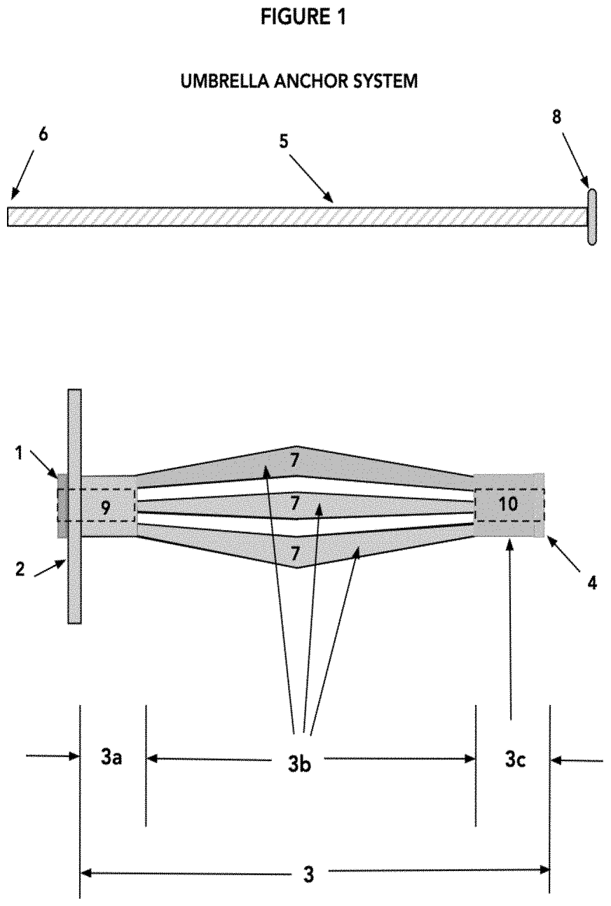

The component parts each have a place and function as shown in FIGS. 1, 2 and 3

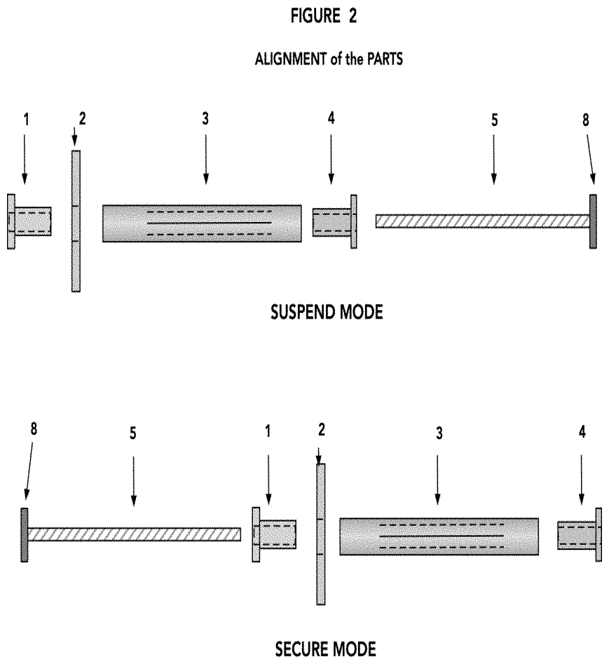

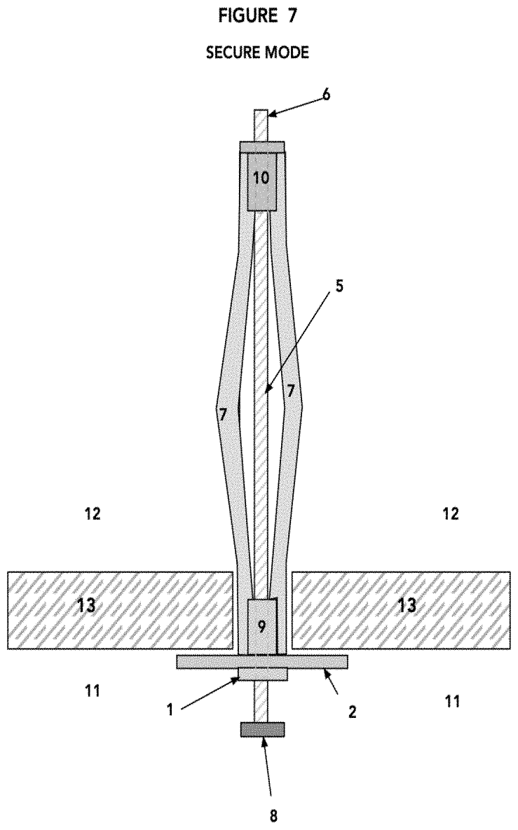

The UAS of FIG. 1 has a SLIDE(9), a GUIDE(10) and an ANCHOR tube(3b) that is sliced into tube ribs(7). In FIG. 2, the SLIDE(9) is made by inserting a shoulder sleeve washer (1) into a washer 2) and then permanently affixing the shoulder sleeve washer (1) into the bottom section of a tube(3a). The SLIDE (9) stops the UAS as it penetrates into the entry hole(15) of the HBS(13) as shown in FIGS. 7 and 12

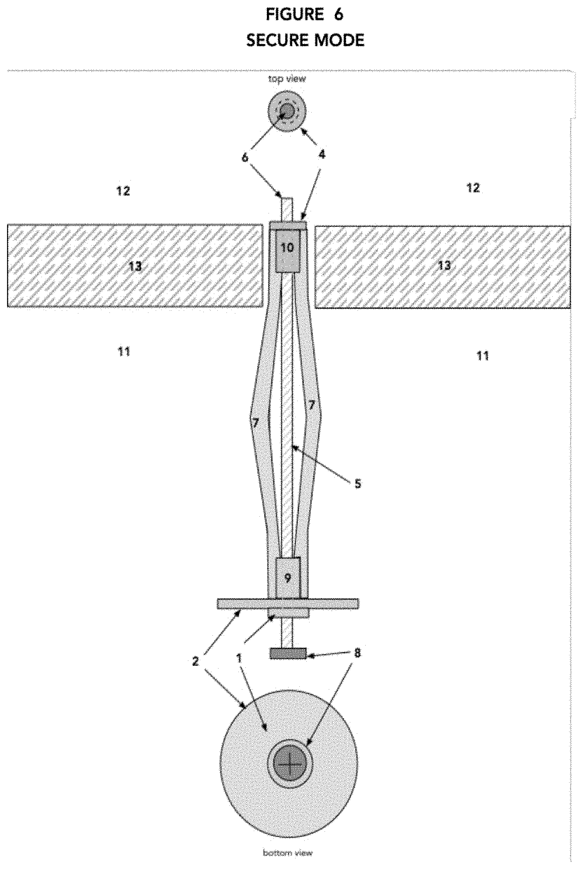

Second, the GUIDE (10) of the UAS is made by permanently affixing a rivet nut(4) into the top end of the tube(3c). The GUIDE (10) becomes the track for the threads of a screw (5) or threaded rod. The GUIDE (10) is the spearhead that starts the penetration of the UAS into the entry hole(15) of the HBS(13). FIGS. 6 and 11

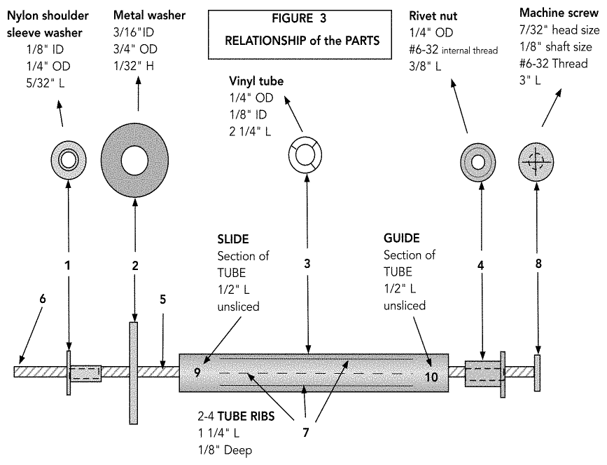

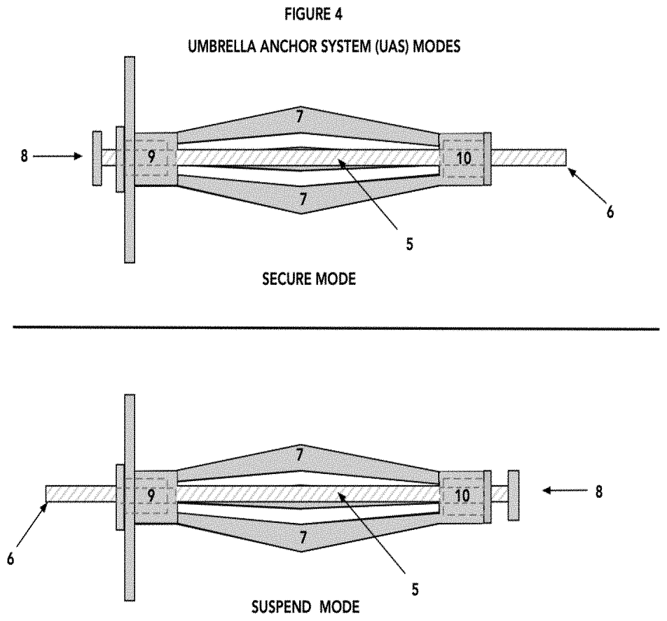

From FIGS. 3 and 4 we can see that the screw (5) distal end(6) can enter the GUIDE (10) from either end. When the screw(5) distal end(6) enters the GUIDE (10) from the SLIDE (9) end, the UAS is in the SECURE MODE. When the screw (5) distal end(6) enters from the GUIDE (10) end, the UAS is in the SUSPEND MODE.

Last, the ANCHOR tube(3b) of the UAS is made by slicing longitudinally through the exterior surface of the tube(3)'s midsection in a number of places between the tube(3a) and the tube(3c) with a into hollow center forming The ANCHOR tube(3b) comprised of tube ribs(7) shown in FIGS. 1,3 and 4.

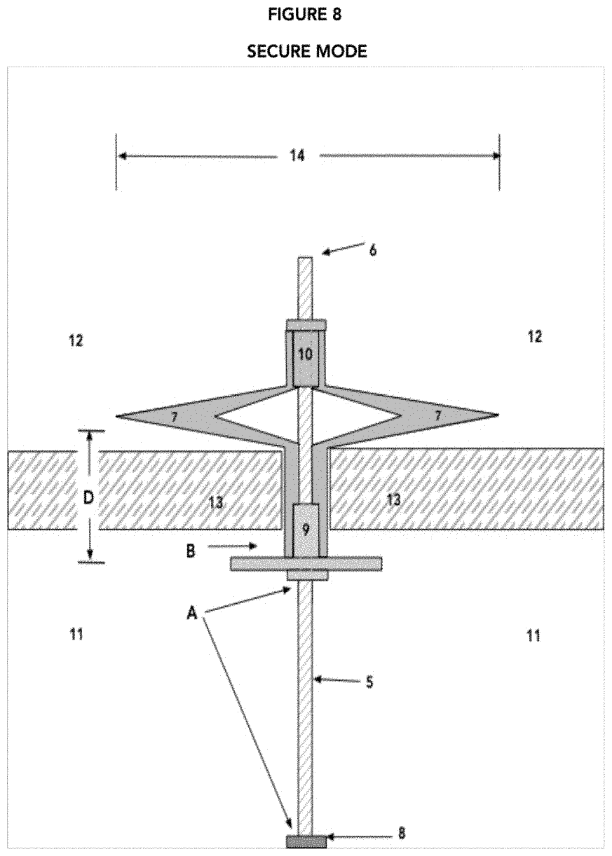

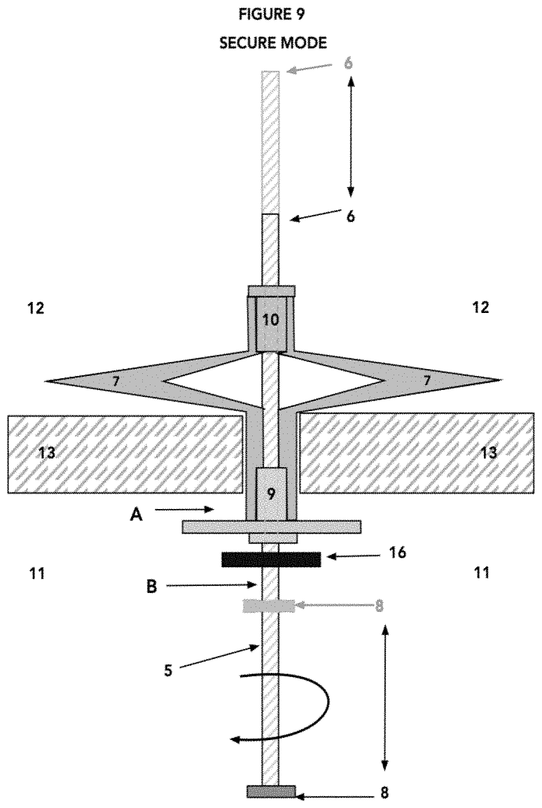

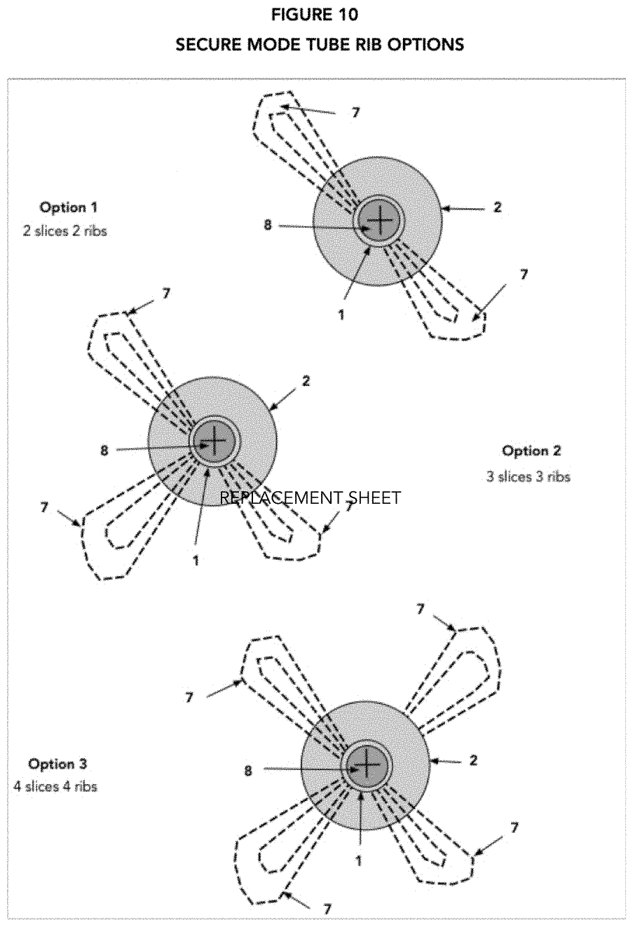

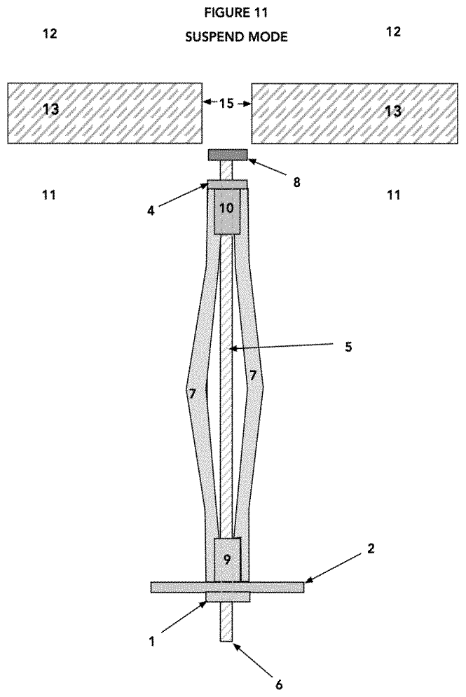

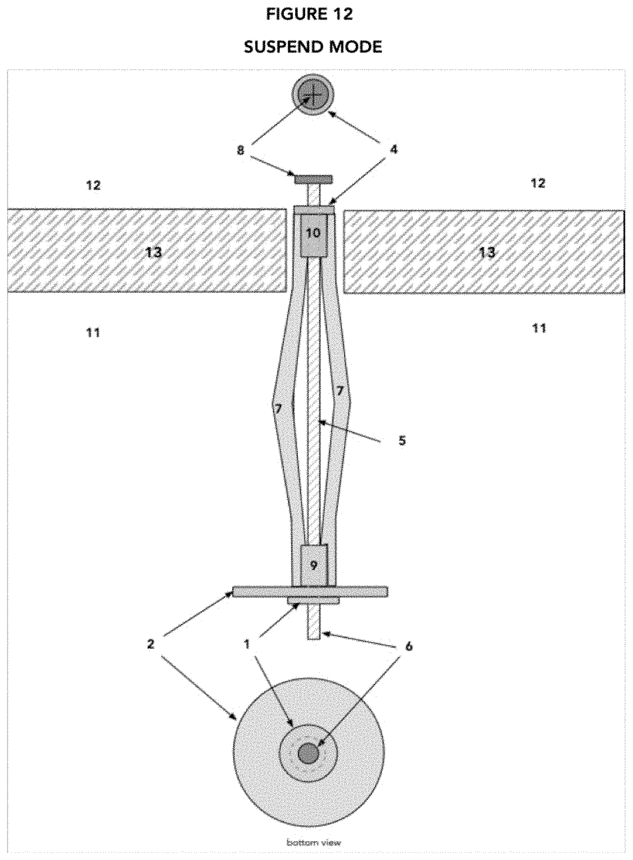

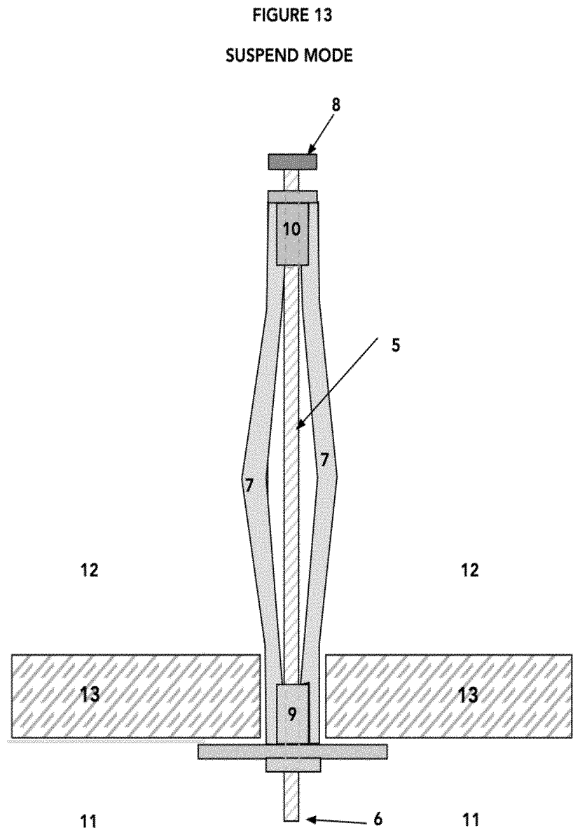

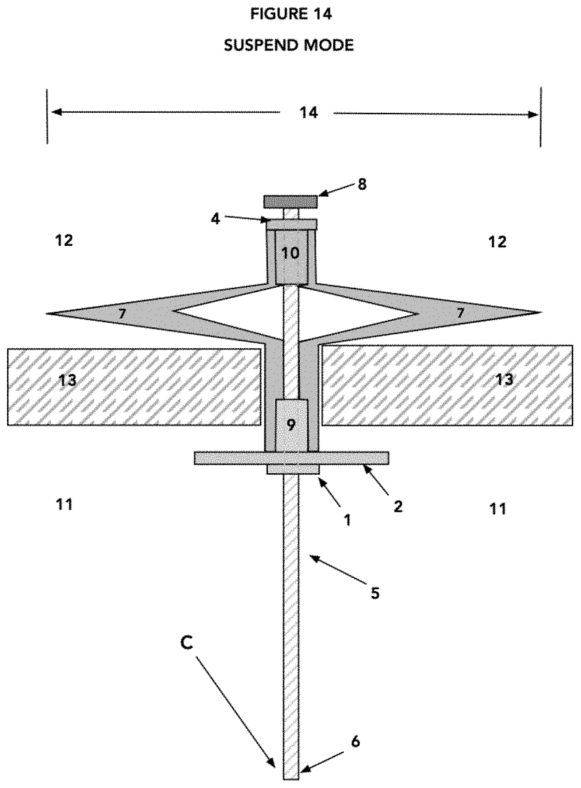

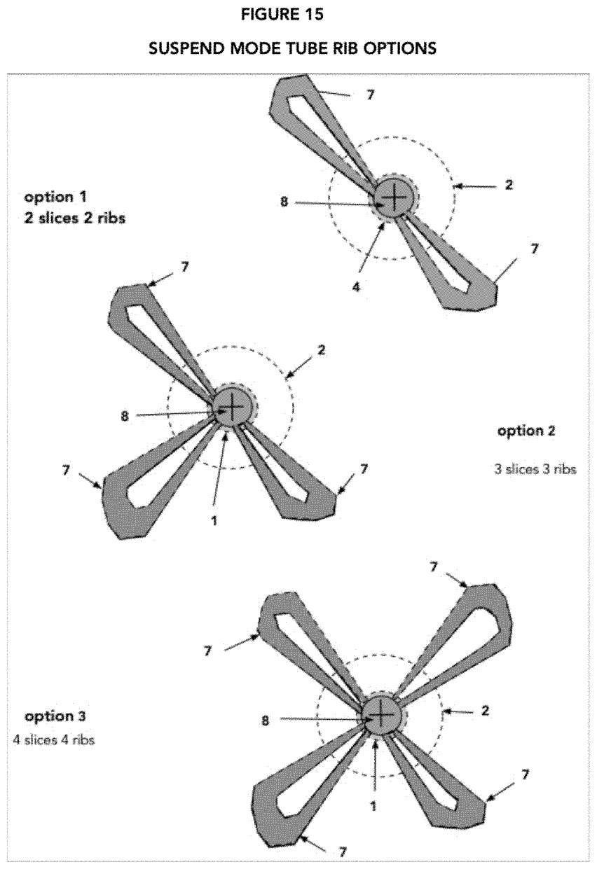

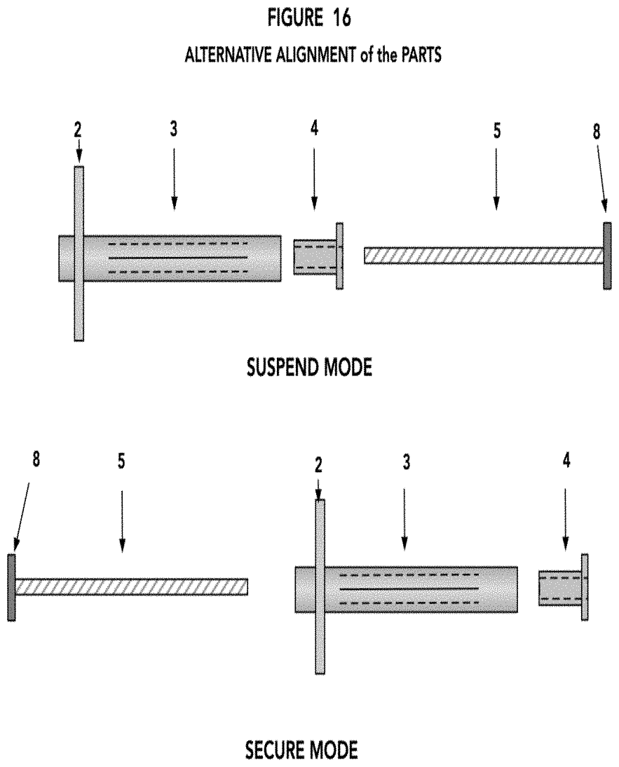

FIGS. 7, 8, 12 and 13 show that when the screw(5) is secured inside the GUIDE(10), the UAS can enter through an entry hole(15) or pegboard hole into the hollow space(12). of the HBS(13) Changing the distance between the GUIDE (10) and the SLIDE (9) is what opens and closes, (that is, collapses and flattens), the tube ribs(7) of the UAS. This can be done quickly, by pulling the GUIDE(10) toward the SLIDE(9) as seen in FIGS. 8 and 13 or methodically by rotating the screw(5) through the GUIDE (10) as in FIG. 9

### DETAILED DESCRIPTION OF THE INVENTION

The tube(3) material determines springback potential, entry hole size, and relative strength of the splash(14) to support weight as seen in FIGS. 10 and 15. For example, in SUSPEND MODE situations, an ANCHOR tube(3b) with rubber tube ribs (7) springs back to its original position quicker than vinyl tube ribs(7). This trait is useful for speed transfers as well as facilitating one hand removals and reanchoring—the rubber making for a faster transfer of the weight attached. If the force of weight experienced on a hook attachment, for example, is less than the springback force of the tube(3) material, the speed to release the UAS from the entry hole(15) is increased. Vinyl, on the other hand, takes little or no weight to stay anchored, with little springback potential force. The UAS can be manufactured to offer both options.

From FIGS. 3, 7 and 13, determining a tube length is important because the UAS is designed to open in the hollow space(12) behind a HBS(13). Therefore, to reach that space(12), an appropriate length of tube(3a) comprising the SLIDE(9) section is to be understood.

In FIGS. 10 and 15, the number of longitudinal cuts, or slices, and the distance separating these slices in the tube(3b) will determine how much fiction and potential springback force the tube ribs(7) will exhibit on the screw(5) shaft.

Another advantage of the UAS is the possibilites for the aesthetic design when considering washer and tube material. Color, shape, texture. among other features can make the UAS a more functional and attractive feature.

The UAS can be attached to any length of screw(5) or threaded rod that has distal end(6) threads appropriate for the GUIDE(10) track. The screw(5) can be totally or partially threaded for other designs and functions, like hooks.

In the SECURE MODE of FIG. 4, a threaded screw(5) and screwhead(8) can be any length and diameter necessary to accomodate attachments, accomplish distancing requirements between attachments, clamping strength and other traits. This gives the advantage of numerous possibilities for attachments into HBS(13) comprising both drywall and pegboard including ceilings, storage closets and garage workshops, to name a few.

### DETAILED DESCRIPTION OF THE INVENTION

Looking at FIG. 1, the GUIDE(10), comprising the rivet nut(4) inside the top unsliced section of the tube(3c), is the spearhead that begins the penetration into the entry hole(15) of the HBS(13). The smaller the GUIDE(10) components, the smaller the screw(5) diameter, and therefore the smaller the entry hole(15) needs to be, and vice versa. FIG. 6

The material of the rivet nut(4) can also be important since its dimensions will determine diameter of the entry hole(15). When manufacturing and engineering design possibilities are explored, factors, like tube(3) dimensions, conductivity for electrical connections or protection from damage when the UAS is driven into a surface making its own entry hole(15), may open other ways the UAS can be adapted into other fields.

The SLIDE (9) has as its main function to be the stopping point when the UAS penetrates through the entry hole(15) into the HBS(13). In conjunction with GUIDE (10), the SLIDE(9) determines the location on the screw head(8), its screw shaft(5), or distal end(6) where an attachment will be placed as seen in FIGS. 9 and 14 denoted as A, B, and C.

The SLIDE(9) moves up and down the screw(5) shaft. The more friction the SLIDE(9) presents on the shaft, the more likely it is to stay at a certain location. There are times when an clamp or stopper(16) is necessary to facilitate some friction on the screw shaft for locating purposes as in FIG. 9.

The material choices for the tube(3a) and the SLIDE(9) as well as the number and location of the tube ribs (7), determine friction and stopping points along the screw shaft(5). For instance, a rubber shoulder washer has more friction on the shaft than a nylon shoulder washer. The unsliced portion of the tube(3a) has friction properties of its own and can itself substitute for the shoulder sleeve washer(1) by using a different tube(3) material or changing the location for the washer(2). FIG. 16

### DETAILED DESCRIPTION OF THE INVENTION

The length of tube(3a) between the SLIDE(9) and the beginning slices of the tube ribs(7) should be suitable to accomodate the distance (D), in FIG. 8, between the outside surface(11) where the SLIDE(9) stops and the hollow space(12) behind the HBS(13) trying to be reached.

FIGS. 6,7 and 10 show that the SLIDE(9) is visible from the outside(11) of the HBS(13), so aesthetics come into play. Since the SLIDE(9) comprising shoulder sleeve washer (1) and washer (2) will visually be seen, design possibilities for color, material, size, shape, attachment design, among other things can change the SLIDE(9)'s appearance, strength, friction and springback properties on the screw(5).

The UAS can be used as either a fastener for attachments, SECURE MODE, into an HBS(13) or as an anchor of attachments, SUSPEND MODE, from an HBS(13).

This depends into which side of the GUIDE(10) the fastener or anchor, in this case a machine screw(5), enters first, as seen in FIG. 4. If the screw distal end(6) is rotated and secured into the GUIDE(10) first and then the SLIDE(9), the UAS can suspend or anchor attachments from an HBS(13). If the screw distal end(6) is inserted through the SLIDE(9) first and then the GUIDE(10), UAS can be used as a fastener for securing attachments to an HBS(13)

These two entrance choices leave options for placement of attachments.

When using the UAS in the SECURE MODE, the first option, placement A in FIG. 8, is along the screw (5) shaft between the screwhead(8) and the SLIDE(9)). By taking the screw(S) totally out of the UAS as in FIG. 1, the screw(5) can easily accept attachments as exemplified by a washer, spacer, hook, etc., replacing it back through the SLIDE(9), and removably secured into the GUIDE(10).

The second option, position B in FIG. 8, is to place the attachment onto the section of unsliced tube(3a) just above the SLIDE(9) and below the sliced tube ribs (7) of ANCHOR (tube 3b).

The third option, the placement C shown in FIG. 14, is when the UAS is used in the SUSPEND MODE, where the attachment, such as a handle or hook, has an adaptive post with compatible threads that can accept the distal screw end(6).

### DETAILED DESCRIPTION OF THE INVENTION

Here is how to make the Umbrella Anchoring System (UAS) using the dimensions of the parts described on FIG. 3 and the MODE choices in FIG. 4.

To make the SLIDE (9), permanently glue the shoulder sleeve washer (1) into the washer(2) and into the bottom of the tube(3a). This is best done while all three are on the screw/shaft (5).

The washer(2) is wedged between the shoulder sleeve washer (1) and the tube(3a) bottom rim to prevent the washer(2) from moving lineally up the exterior surface of the tube(3) (as seen in the UAS design variation of FIG. 16) but still allowing the shoulder sleeve washer (1) its ability to slide up and down on the screw/shaft (5).

To make the GUIDE(10), insert the screw(5) into the SLIDE(9), through the ANCHOR (tube 3b) and attach the rivet nut(4) to the threaded screw distal end (6) and permanently glue the rivet nut(4) to the inner circumference of the top of the tube(3c). The screw (5) can be removed from the UAS at this point, but for the next operation leave it threaded into the GUIDE(10).

The UAS tube(3) unit is divided into three sections (1) the bottom tube(3a) (2) the midsection tube(3b), and (3) the tube(3c). In the midsection, tube(3b) comprises tube ribs(7) which are 2-4 parallel longitudinal cuts, slicing through the exterior surface of the tube(3b) so that the knife blade reaches to the hollow center and the knife point is stopped by the screw/shaft (3) fully engaged through the tube(3) hollow center. This creates the tube ribs(7) which collapse and flatten, like an umbrella, when the SLIDE(9) moves up and down along the screw/shaft(5).

Test all the parts by pushing the SLIDE(9) up and down the screw/shaft(5), making sure the tube ribs(7) open and close the umbrella anchor properly. Test the GUIDE(10) track thoroughly by rotating the screw(5) through the rivet nut(4) and lubricate if necessary.

The UAS can also be made by using less than the five parts shown in FIG. 2.

First, by changing the washer(2) location as in FIG. 16, or other traits like washer(2) size and material make-up, the placing of the washer(2) over the exterior of the bottom section of the tube(3a) eleiminates the shoulder sleeve washer(1) if friction and springback purposes are satisfactory.

### DETAILED DESCRIPTION OF THE INVENTION

Second, the shoulder sleeve washer does not have to slide freely along the screw shaft, but by choosing a different material, such as rubber or neoprene for their friction properties, the washer(2) can be eliminated.

The UAS can also unify the SLIDE(9), TUBE(3), and the GUIDE(10) by having them engineered and manufactured as one piece.

A specific machine screw(S) is technically part of the UAS, but since it is a fastener separate from the anchoring sections of parts 9,10 and 7, it too can change but not be eliminated. The two parts do work together to perform the anchoring and fastening requirements, the screw(S), rod or shaft being an activator for umbrella anchoring splash(14)

The flexible, cylindrical tube(3) can be rubber, vinyl or other materials and can vary to accomodate friction and springback capabilities. These are necessary traits when determining removal and transfer speeds from entry hole(15) to entry hole(15), as in a wallpaper carriage on a ceiling in the example mentioned previously. Provisional Patent: Jul. 2, 2019 APP. Nos. 62/869/796.

The length of the screw(5) can be changed and thus the length of the tube(3).

The machine #6-32 thread size is arbitrary as long as all other parts and dimensions are appropriate and proportional. With engineering and manufacturing refinements, a hard, conical point can also be attached to the threaded rod(5) on either the screwhead(8) or distal end (6) so that the UAS can be driven, like a nail, or shot with an air compressor into the HBS(13) to facilitate the making its own entry hole(15).

When used in the SUSPEND MODE, the screw-head(8) can be eliminated or measured to be equal or less than the diameter of the tube in order to penetrate into an entry hole(15).

However, when in the SECURE MODE, a larger diameter screw head(8) can be used for securing an attachment to a HBS(13). In this case, the screw head(8) can hold attachments along the screw/shaft(5) by compressing them together as the screw(5) rotates into the GUIDE(10) and toward the SLIDE(9). The larger diameter screwhead(8) helps securing attachments that need the larger screw head diameter, such as a wire on a picture frame, for safety, strength or reliability.

### DETAILED DESCRIPTION OF THE INVENTION

The number of parallel longitudinal slices through the exterior surface of the tube(3) to make the tube ribs(7) can change, as well as the distance between cuts. This operation will affect the friction of the tube(3) along the screw/shaft(5) as well as the speed that the tube ribs(7) springback.

The UAS solves two deficiencies of other hollow back surface fasteners and anchors. First the UAS can secure, suspend, pull or carry weight in the form of attachments on any hollow backed surface HBS(13) in any direction with little damage to the surface. Second the UAS is movable and reusable and can quickly and safely transfer the weight to another location. Here is how the UAS works.

FIG. 1 shows the two separate components of the UAS. The umbrella anchor and the appropriate screw fastener that passes through it. FIG. 8 shows the places, A and B, where attachments can be placed when the UAS is used in the SECURE MODE. FIG. 14 shows the distal screw end (6), D, where attachments can be placed when the UAS is used in the SUSPEND MODE.

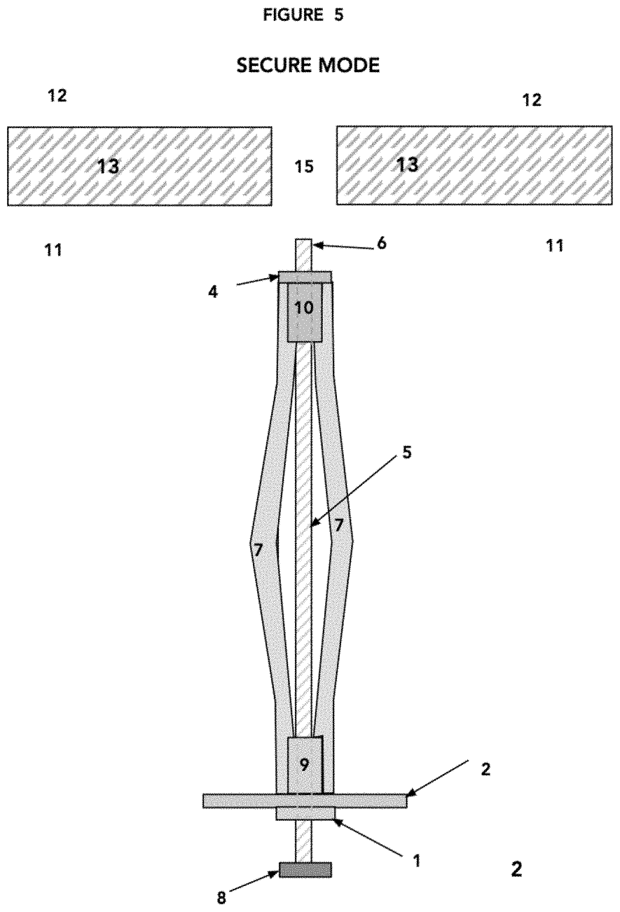

FIG. 5 shows the UAS in position to enter through a pre-drilled drywall entry hole(15) or pegboard hole for the SECURE MODE in an HBS(13) and FIG. 11 shows the UAS in position to enter through a pre-drilled entry hole(15) or pegboard ceiling hole for the SUSPEND MODE of an attachment from an HBS(13).

As seen in FIGS. 7 and 13, the UAS is in the same position for both the SECURE MODE and the SUSPEND MODE, the only difference being the direction of the screw fastener and the positioning of attachments as seen in FIG. 9.

With the tube ribs(7) flat, the GUIDE(10) fully penetrates into the HBS entry hole(15) or pegboard hole, while the SLIDE(9) stops the inward progress when it abutts to the outside surface(11) as in FIGS. 7 and 13.

The ANCHOR tube(3b) is now in the hollow space(12) where the collapse of the tube ribs(7) will create the umbrella ANCHOR's splash(14) as seen in FIGS. 8,9 and 14.

To make this umbrella ANCHOR splash(14) requires the flat tube ribs(7) to bend flexibly and collapse. Any resistance is called the springback force.

### DETAILED DESCRIPTION OF THE INVENTION

When collapsing the tube ribs(7), either pull the screwhead(8) lineally through the SLIDE(9) or rotate the screwhead(8) into the GUIDE (10) until it is tight and secure. The motion to collapse can be paused at a desired location on the screw shaft where an attachment can be stationed with clamps or stoppers(16) that limit or set parameters on potential springback. FIG. 9

By pulling the screwhead(8) or rotating the screwhead(5), the SLIDE(9) is drawn lineally along the screw(5) shaft closer to the GUIDE(10) thereby collapsing the tube ribs(7) of the umbrella ANCHOR creating the splash(14), which is a platform of tube ribs whose diameter is larger than the hole it entered.

In the SECURE MODE, relocate the UAS and its attachments, by removing the screwhead(8) from the UAS and pull the flexible UAS from the entry hole(15) in the HBS(13).

In the SUSPEND MODE to relocate the UAS and its attachments, push the distal screw end(6) and attachments toward the SLIDE(9). This will collapse the tube ribs(7) making the splash(14) of the UAS removably flat.

An example of a UAS attachment, transfer and reanchor is the wallpaper carriage associated with the Provisional Patent 62/869,796. The handle of that invention is based in U.S. Pat. No. 5,743,485, which has been marketed as the Border Hold-up. In this example, the handle of the border surface attachable tool is adapted with a female threaded post to accept the threads of the distal screw end(6) of the UAS. The handle supports carriage that will carry an entire roll of wallpaper. The handle can anchor the carriage from one small entry hole(15) in the ceiling, letting the installer use two hands to work, and then be relocated into another entry hole(15).

### OTHER USES FOR THE INVENTION

The physics behind the Umbrella Anchoring System UAS is such that it could have uses in other fields of technology. To anchor, pull, support, hold, secure or suspend a weight in any direction reliably and safely makes the UAS very versatile. Moreover, it is quick to remove, reanchor and reuse.

The UAS can pull objects together, separate objects into determined distances or spaces, hold objects, pick up objects, connect objects, even clamp. Many fields of technology could benefit from the addition of these qualities in such a simple anchor

Of course, there are advantages with good engineering, design and manufacturing. Developing the multitude of combinations of materials, sizes, shapes and textures that the few parts comprise make the UAS open to a large variety of compatible attachments and useful ideas benefitting others. With a little imagination fields like architecture, building and construction, design and decorating, aerospace, automotive, nautical, medicine, agriculture, electrical, sports, theater, crafts, woodworking, physical sciences, civil engineering, mechanical engineering, environmental engineering, industrial engineering, mountain climbing and others may find an unsolved need met or a new application discovered using the UAS.

Therefore, an Umbrella Anchoring System may someday anchor a boat in a dock, make electrical connections, pull skin or muscle tissue together, help rock climbers. In construction, the UAS technology may pull walls or floors together, clamp laminated layers, anchor astronaut tethers. In architecture, the Umbrella Anchoring System can open up areas of design and engineering where structural strength with current technology won't work. The Umbrella Anchoring System may someday be adapted to pull dents out of cars, suspend and relocate lights, anchor plant hooks into ceilings, create pegboard ceilings for garages and closet, and, of course, the reason it was first invented, to hold wallpapers on ceilings so the installers hands are free.

1. A movable anchoring system for a hollow back wall, ceiling or pegboard surface comprising a fastener rod enclosed by a sliced, cylindrical, flexible, hollow tube that is removably secured passing through a washer assembly embedded into a bottom section of said tube and into a rivet nut embedded into a top section of said tube.

2. An anchoring system wherein said tube of claim 1 is able to collapse radially with respect to said fastener rod axis when sliced to the hollow tube center in its midsection with a number of longitudinal cuts that form independent and separate tube ribs around the circumference of said rod.

3. An anchoring system wherein said top rivet nut section and said bottom washer assembly section of said tube in claim 1 and 2 remain unsliced.

4. An anchoring system wherein said washer of claim 1, 2 and 3 can be slid up along said fastener rod lineally thereby opening an umbrella anchoring platform comprised of the collapsed sliced tube ribs of said tube or slid down along said fastener lineally thereby flattening or closing said umbrella anchoring platform.

5. An anchoring system wherein said unsliced washer assembly bottom section of said tube of claim 1 and 3 is able to accept an attachment.

6. An anchoring system wherein said washer assembly bottom section of said tube of claim 1 and 4 provides an amount of friction for determining said assembly slide speed, said tube springback qualities and said washer assembly location along said rod.

7. An anchoring system wherein said fastener rod of claim 1, 2, 3, 4 and 6 has a threaded portion that can rotate into or through said top rivet nut section of said tube.

8. An anchoring system wherein said fastener rod of claim 1, 2, 4, 6 and 7 is comprised of a head and a distal end able to accept attachments.

9. An anchoring system wherein said fastener rod and said umbrella anchoring platform of claim 1, 4 and 8 is removable from one anchoring entry hole and transferable to another anchoring entry hole in said hollow back surface with or without attachments, as one piece or unit.

10. An anchoring system wherein said anchoring platform of claim 2, 4 and 9 flattens when entering or exiting said anchoring entry hole and opens up inside the hollow space behind the surface to become the umbrella anchoring platform comprised of said tube ribs that compress against said surface opposing the pull on the outside of said surface.

11. An anchoring system of claim 1 and 2 wherein said sliced tube has spring back properties determining the removal speed and anchoring weight strength of said anchoring platform from said anchoring entry hole in claim 9 and 10.

12. An anchoring system wherein said anchoring platform in claim 4, 10 and 11 is able to be removed from the fastener or stay attached to the fastener when transferring said anchoring platform from one anchoring entry hole to another anchoring entry hole.

13. A movable anchoring system that is not dependent on anchoring direction or gravity to suspend or secure an attachment to a hollow back surface.

14. An anchoring system using a method of making this anchoring system comprised of (1) inserting and securing into said tube top section a rivet nut and (2) inserting and securing into said tube bottom section a washer assembly, in this case, a fender washer and a shoulder washer, and (3) putting them all together while on the fastener, then (4) using a cradle to stabilize the unit and (5) longitudinally razor slicing the midsection of said tube in a number of places around its circumference (6) making sure the sliced midsection will collapse into umbrella splash type form with said tube ribs expanding sideways as the rivet top section of said tube is lineally compressed along the rod shaft toward the bottom washer section, finally (7) lubricating said fastener as it connects and threads correctly through either entry side of the top section of said tube containing said rivet nut.
